(19) United States
(12) Patent Application Publication
(10) Pub. No.: US 2008/0186630 A1
(43) Pub. Date: Aug. 7, 2008

(54) STRUCTURE TO MOUNT HEAD STACK ASSEMBLY ON BASE MEMBER AND HARD DISK DRIVE INCLUDING THE SAME

(75) Inventors: Sung-chul HUR, Suwon-si (KR); Sung-wook Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/023,335

(22) Filed: Jan. 31, 2008

(30) Foreign Application Priority Data
Feb. 5, 2007 (KR) 2007-11796

(51) Int. Cl. G11B 5/48

(52) U.S. Cl. 360/244

(57) ABSTRACT

A head stack assembly (HSA) mounting structure and a hard disk drive (HDD) including the assembly includes a base member including a shaft protruding upwards and a shaft circumference groove formed around the shaft. An HSA is rotatably placed on the shaft through a pivot bearing including an inner case contacting the shaft, and including a lower end portion received in the shaft circumference groove. A cover member may be coupled to the base member and a fixing screw may pass through the cover member to be threadedly coupled to the shaft.

### CROSS-REFERENCE TO RELATED APPLICATIONS

This application claims the benefit of priority under 35 U.S.C. 119(a) of Korean Patent Application No. 10-2007-0011796, filed on Feb. 5, 2007, in the Korean Intellectual Property Office, the disclosure of which is incorporated herein in its entirety by reference.

### BACKGROUND OF THE INVENTION

1. Field of the Invention

The present general inventive concept relates to a hard disk drive (HDD), and more particularly, to a head stack assembly (HSA) mounting structure to rotatably mount an HSA on a base member and an HDD including the HSA mounting structure.

2. Description of the Related Art

A hard disk drive (HDD) is an auxiliary memory device to use in a computer, an MP3 player, a mobile phone, and the like. That is, the HDD is a device that writes/reads data to/from a data storage disk having disposed thereon a data writing/reading medium which can be written to and read from by a magnetic head mounted on a head slider. When the HDD operates, the head slider is lifted off of the data storage disk to form a predetermined gap and is maintained there in a floating state. The magnetic head mounted on the head slider writes/reads the data to/from the data storage disk while the head is in the floating state.

The head slider is attached to a distal end of each arm of a head stack assembly (HSA) and the head slider is moved to a target location of the data storage disk by the HSA. The HSA is rotatably mounted on a base member of the HDD.

FIG. 1 is a longitudinal cross-sectional view illustrating a conventional HSA mounting structure, and FIG. 2 is a longitudinal cross-sectional view illustrating another conventional HSA mounting structure.

Referring to FIG. 1, the conventional HSA mounting structure includes a base member 11 having a shaft 13 that protrudes upward, and an HSA 20 that is rotatably placed on the shaft 13. The HSA 20 includes a pivot bearing 25 to minimize friction between a swing arm 21 and the shaft 13. The pivot bearing 25 includes an inner case 26 contacting the shaft 13, an external case 28 press fit into the swing arm 21 so as to be captured therein, and a plurality of bearing balls 29 interposed between the inner case 26 and the external case 28.

The HSA mounting structure includes first and second fixing screws 31 and 33 fixing the HSA 20 in the longitudinal direction of the shaft 13, that is, a Z direction. The first fixing screw 31 fixes the HSA 20 on the shaft 13 when the HSA 20 is rotated so that a head slider (not illustrated) mounted on an end of the HSA 20 may be positioned in a parking zone (not illustrated), e.g., an inner circumferential portion of a disk 17, when a cover member 15 is not yet mounted. The first fixing screw 31 is coupled to the shaft 13. After the cover member 15 is coupled to the base member 11, the second fixing screw 33 is coupled to the first fixing screw 31. Thus, the HSA 20 is further prevented from moving in the Z direction.

However, since the HSA mounting structure is one in which the second fixing screw 33 is coupled to the first fixing screw 31, which is coupled to the shaft 13, the axis of the first fixing screw 31, to which the second fixing screw 33 is coupled, may not be aligned with the axis of the second fixing screw 33. Accordingly, it is difficult to couple the second fixing screw 33 to the first fixing screw 31, and also, the second fixing screw 33 often cannot be disassembled from the first fixing screw 31 after the second fixing screw 33 is coupled to the first fixing screw 31. In the latter case, the cover member 15 cannot be separated from the base member 11, and thus the HDD cannot be repaired, and potentially recoverable components in the HDD are lost.

Referring to FIG. 2, another conventional HSA mounting structure includes a base member 51 having a mounting hole 53 and an HSA 60 that is rotatably mounted in the mounting hole 53. The HSA 60 includes a pivot bearing 65 to minimize friction between a swing arm 61 and the base member 51. The pivot bearing 65 includes a bearing shaft 66 that is coupled to the mounting hole 53 by a screw, an external case 68 press fit into the swing arm 61, and a plurality of bearing balls 69 interposed between the bearing shaft 66 and the external case 68.

The HSA mounting structure of FIG. 2 further includes a fixing screw 71 preventing the HSA 60, including the pivot bearing 65, from moving in the Z direction. When the HSA 60 is rotated prior to attaching a cover member 55 so that a head slider (not illustrated) mounted on an end of the HSA 60 may be positioned in a parking zone (not illustrated), the HSA 60 cannot move in the Z direction since the bearing shaft 66 is coupled to the base member 51 by a screw. After the cover member 55 is coupled to the base member 51, the fixing screw 71 is coupled to the bearing shaft 66 through the cover member 55.

In the HSA mounting structure of FIG. 2, the fixing screw 71 is coupled to the bearing shaft 66, and the rotation axis of the bearing shaft 66 may not correspond with the axis of the fixing screw 71. Accordingly, it is difficult to couple the fixing screw 71 to the bearing shaft 66, and often, the fixing screw 71 cannot be disassembled from the bearing shaft 66 after the fixing screw 71 has been coupled to the bearing shaft 66. In addition, the bearing shaft 66 may jam in the mounting hole 53 of the base member 51 to the extent that removal of the bearing shaft 66 is not possible. In such cases, the cover member 55 cannot be disassembled from the HSA mounting structure, and thus the HDD cannot be repaired, and potentially recoverable components in the HDD are lost.

### SUMMARY OF THE INVENTION

The present general inventive concept provides a head stack assembly (HSA) mounting structure that can be manufactured and mounted using simple processes, and a hard disk drive (HDD) including the HSA mounting structure.

According to an aspect of the present general inventive concept, the HSA mounting structure is prevented from jamming when coupled by a screw.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a head stack assembly (HSA) mounting structure including a base member including a shaft protruding upwards and a shaft circumference groove formed around the shaft, an HSA that is rotatably placed on the shaft, and includes a pivot bearing including an inner case contacting the shaft, and including a lower end portion received in the shaft circumference groove, an external case disposed outside of the inner case, and at least one bearing member interposed between the inner case and the external case, a head slider supporting member coupled to the external case, and a head slider mounted at an end of the head slider supporting member, a cover member coupled to the base member and a fixing screw passing through the cover member and coupled to the shaft, and a hard disk drive (HDD) including the HSA.

The HSA mounting structure may further include an escape blocker engaging the lower end portion of the inner case to prevent its release from the shaft circumference groove before the fixing screw is coupled.

The escape blocker may include a protrusion protruding from a side surface of the lower end portion of the inner case, and a protrusion capture groove concaved so as to house the protrusion in a side surface of the shaft circumference groove.

The escape blocker may include a pivot bearing holder fixed to the side surface of the shaft circumference groove, elastically pressing the side surface of the lower end portion of the inner case inserted in the shaft circumference groove, and formed of an elastic material.

The escape blocker may further include a protrusion protruding from the side surface of the inner case to press fit to the pivot bearing holder or to contact a lower end of the pivot bearing holder.

The foregoing and/or other aspects and utilities of the present general inventive concept are also achieved by providing a head stack assembly mount including a base having a mounting surface, a shaft extending from the mounting surface of the base, a shaft circumference groove formed in the mounting surface of the base around the circumference of the shaft, a swing arm to retain a plurality of read/write heads in spaced apart relationship one to another, and a bearing assembly to couple a pivot point of the swing arm with the shaft, the bearing assembly being received in the groove of the base when mounted on the shaft.

The foregoing and/or other aspects and utilities of the present general inventive concept are also achieved by providing a base member of a hard disk drive including a shaft protruding from a mounting surface thereof, and a shaft circumference groove formed in the mounting surface around the periphery of the shaft.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a longitudinal cross-sectional view illustrating a conventional mounting structure of an HSA;

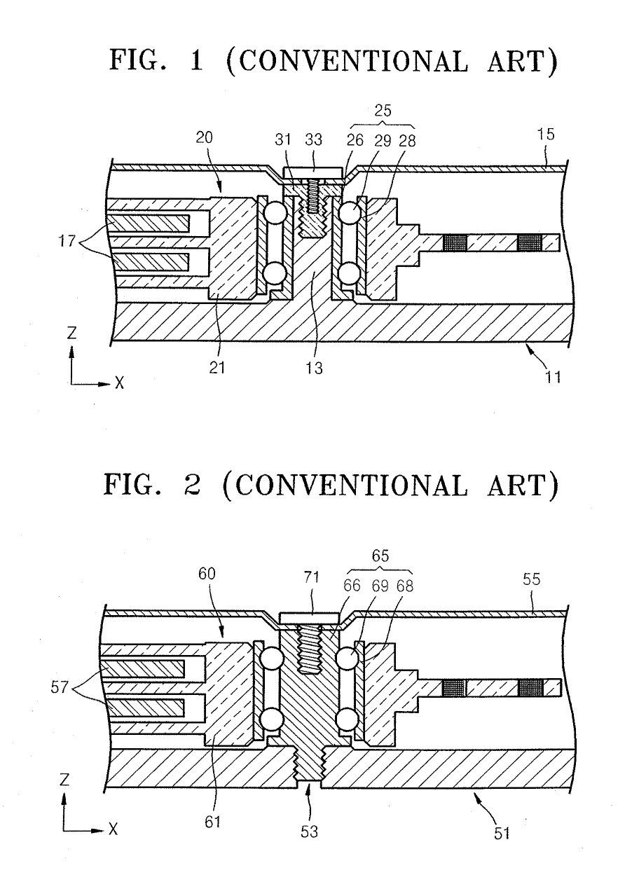

FIG. 2 is a longitudinal cross-sectional view illustrating another conventional mounting structure of an HSA;

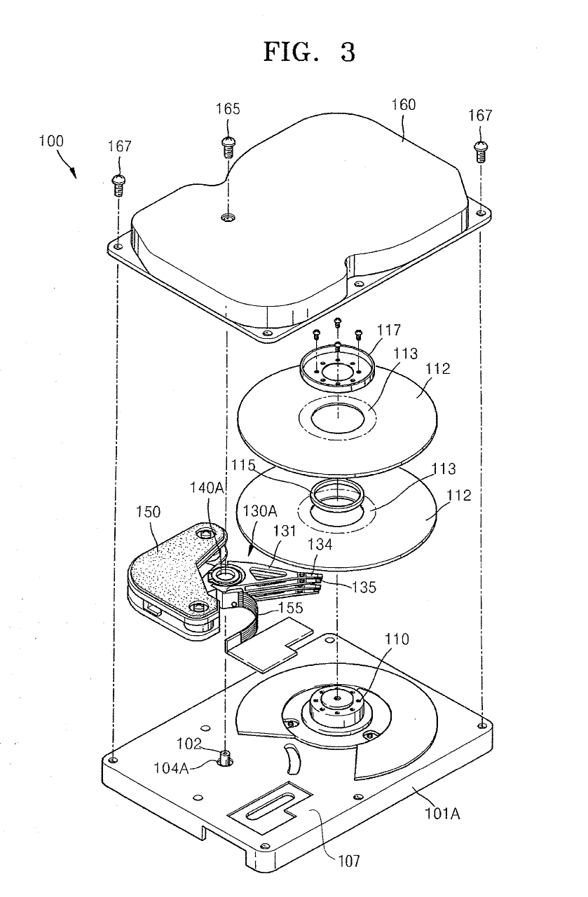

FIG. 3 is an exploded perspective view illustrating a hard disk drive (HDD) according to an embodiment of the present general inventive concept;

FIG. 4 is a longitudinal cross-sectional view illustrating a head stack assembly (HSA) mounting structure included in the HDD of FIG. 3, according to an embodiment of the present general inventive concept; and

FIGS. 5 and 6 are longitudinal cross-sectional views illustrating HSA mounting structures according to two embodiments of the present general inventive concept.

### DETAILED DESCRIPTION OF THE PREFERRED EMBODIMENTS

The present general inventive concept will now be described more fully with reference to the accompanying drawings, in which exemplary embodiments of the invention are shown, and in which like reference numerals refer to like elements throughout. The present general inventive concept may, however, be embodied in many different forms and should not be construed as being limited to the embodiments set forth herein; rather, these embodiments are provided so that this disclosure will be thorough and complete, and will fully convey the inventive concept to those skilled in the art.

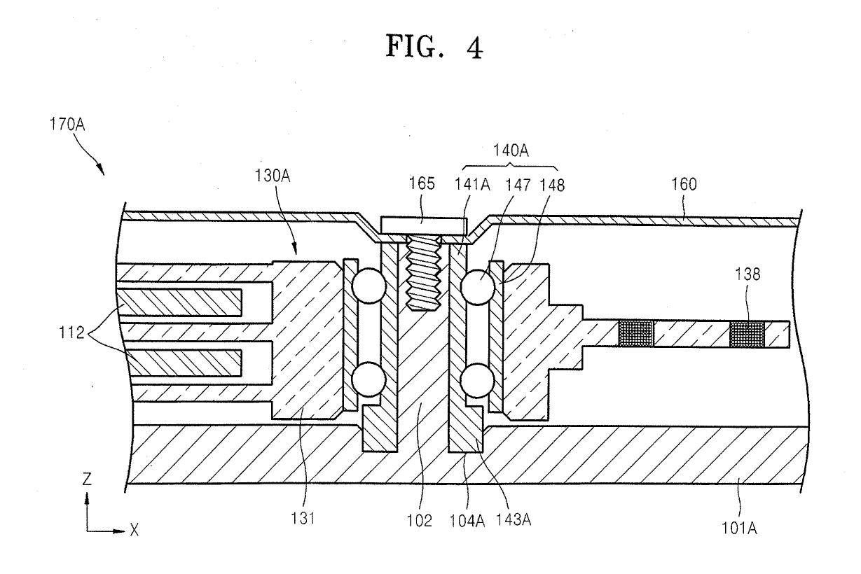

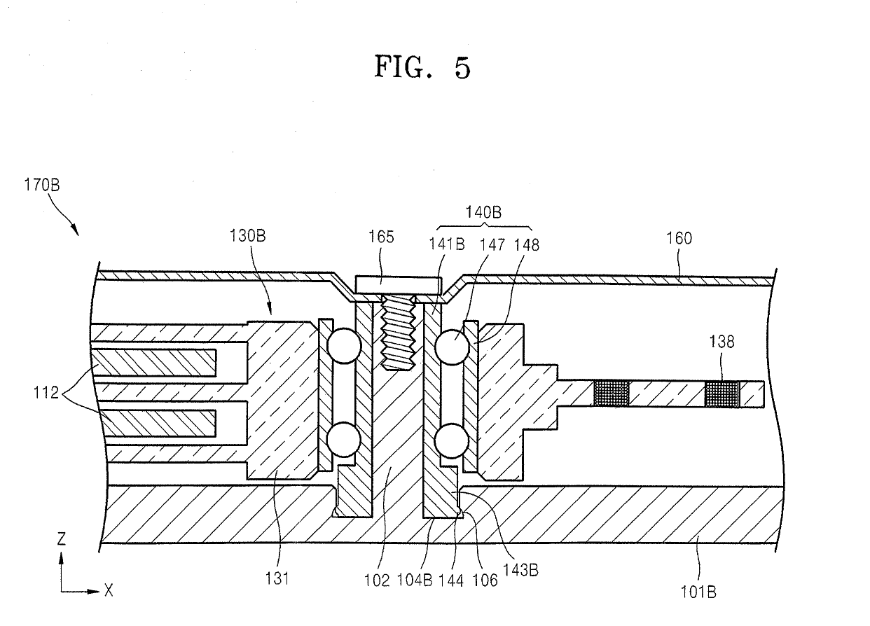

FIG. 3 is an exploded perspective view illustrating a hard disk drive (HDD) 100 according to an exemplary embodiment of the present general inventive concept. FIG. 4 is a longitudinal cross-sectional view illustrating a head stack assembly (HSA) mounting structure included in the HDD 100 of FIG. 3, according to an embodiment of the present general inventive concept.

Referring to FIG. 3, the exemplary HDD 100 includes a base member 101A, a spindle motor 110 mounted on the base member 101A, and a pair of disks 112 to store data, which are mounted on the spindle motor 110 and are rotated at high velocity. In addition, the exemplary HDD 100 includes an HSA 130A comprising a plurality of read/write heads, each having a head slider 135 including a magnetic head recording/reproducing data to/from the disks 112. The exemplary HDD 100 includes a cover member 160 that is coupled to a periphery of the base member 101A to the spindle motor 110, the disks 112, and the HSA 130A and to provide a closed environment around the internal components of the HDD 100.

The disks 112 are mounted on the spindle motor 110 and are spaced a predetermined distance apart by a disk spacer 115 having a ring shape. A disk clamp 117 may be coupled to an upper side portion of the spindle motor 110 to apply a clamping pressure on the disks 112 so as to be fixed to the spindle motor 110.

The HSA 130A moves a magnetic head (not illustrated) mounted on the head slider 135 to a predetermined location on the disks 112 to record/reproduce data on/from the disks 112.

The HSA 130A includes a plurality of head slider supporting members, each supporting the head slider 135 and attached to a swing arm 131 that is rotatably coupled to the base member 101A through a pivot bearing 140A. Each head slider supporting member may include a suspension 134 coupled to an end of the swing arm 131. The head slider 135 is loaded on the end of the suspension 134 so as to be elastically biased towards respective surfaces of the disks 112. A voice coil 138 (see FIG. 4.) may be wound around a rear end of the HSA 130A.

A voice coil motor (VCM) block 150 may be mounted on the base member 101A. The VCM block 150 includes a pair of magnets (not illustrated) disposed on upper and lower parts of the voice coil 138 and a pair of yokes (not illustrated) supporting the magnets. The voice coil 138, the magnets, and the yokes constitute a voice coil motor rotating the HSA 130A. The HSA 130A is rotated in a direction according to Fleming left hand's rule due to an interaction between a current supplied to the voice coil 138 and a magnetic field formed by the magnets. The HSA 130A may be rotated by the VCM and positioned by a servo control system.

The HDD 100 may include a parking system of, for example, a contact start stop (CSS) type. In the CSS system, a parking zone is provided on an inner circumferential portion of the disks 112. When the HDD 100 is turned-off, the HSA 130A is rotated counter-clockwise so that the head slider 135 contacts and parks on the parking zone 113. When the HDD 100 is turned-on and the disks 112 are spun at full speed, the head slider 135 moves from the parking zone 113 to a data zone disposed removed from the parking zone to record/reproduce data.

The HSA 130A may be electrically connected to a main circuit board (not illustrated), which may be mounted on a lower surface of the base member 101A and connected to a flexible printed circuit 155.

Referring to FIGS. 3 and 4, an HSA mounting structure 170A to mount the HSA 130A on the base member 101A includes a shaft protruding upwards from an upper surface of the base member 101A and a shaft circumference groove 104A disposed around the shaft 102. The HSA 130A includes a pivot bearing 140A mounted on the shaft 102, and a cover member 160 may be coupled to the base member 101A and to the shaft 102 by a fixing screw 165 passing through the cover member 160.

The pivot bearing 140A includes an inner case 141A contacting an external circumferential surface of the shaft 102, an external case 148 disposed outside the inner case 141A, which may be press fit into the swing arm 131, and a plurality of bearing members 147 interposed between the inner case 141A and the external case 148. It is to be understood that although the bearing member 147 is a bearing ball in FIGS. 3 and 4, the present general inventive concept is not limited thereto. The inner case 141A includes a lower end portion 143A which may be received in the shaft circumference groove 104A.

The respective dimensions of the lower end portion 143A and the shaft circumference groove 104A may be established so that the inner case 141A may not easily move in the upward, or Z, direction. For example, if the lower end portion 143A and the shaft circumference groove 104A are sized for a press fit therebetween, the lower end portion 143A may be prevented from rising out of the shaft circumference groove 104A during, for example, subsequent assembly operations.

The HSA mounting structure 170A may be assembled as follows. First, the pivot bearing 140A may be fixed into the swing arm 131, the inner case 141A of the pivot bearing 140A may be placed on the shaft 102, and the lower end portion 143A of the inner case 141A may be inserted into the shaft circumference groove 104A and press fit therein. The HSA 130A may then be rotated counter-clockwise to park the head slider 135 on the parking zone 113 of the disks 112. The head slider 135 is parked on the parking zone 113 to prevent damage during a coupling operation of the cover member 160 or a testing operation performed after the assembling operation of the HDD 100, since the HSA 130A can rotate freely. The head slider 135 should be parked on the on the parking zone 113 prior to coupling of the cover member 160 in order to prevent rotation of the HSA 130A into a data zone of the disks 112 during that and other subsequent assembly operations.

Prior to the fixing screw 165 being received in the shaft 102, the HSA 130A is prevented from moving upwards in the Z direction due to the friction between the lower end portion 143A of the inner case 141A and the shaft circumference groove 104A. Accordingly, the head slider 135 and the disks 112 are prevented from being damaged from collision of the head slider 135 with the disks 112 when the HSA 130A is rotated into the parking zone 113.

Once the head slider 135 has been parked, the cover member 160 may be coupled to a periphery of the base member 101A by a plurality of screws 167. The fixing screw 165 may be inserted through the cover member 160 to be threadedly coupled to the shaft 102. Since the position of the HSA 130A is maintained by the coupling between the fixing screw 165 and the cover member 160, which is coupled to the base member 101A, the HSA 130A can further be prevented from vibrating.

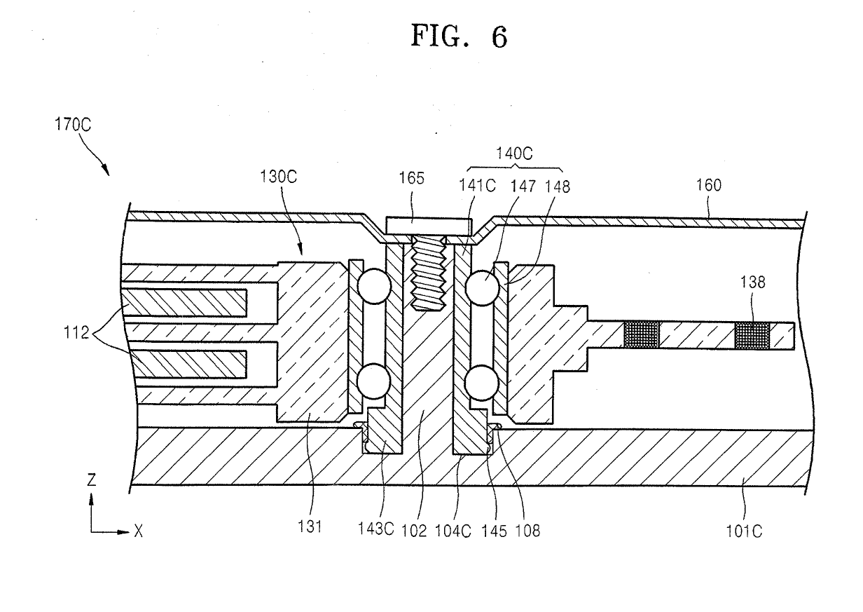

FIGS. 5 and 6 are longitudinal cross-sectional views illustrating HSA mounting structures 170B and 170C according to two exemplary embodiments of the present general inventive concept.

Referring to FIG. 5, the HSA mounting structure 170B includes a shaft 102 protruding upwards, a base member 101B including a shaft circumferential groove 104B formed around the shaft, an HSA 130B including a pivot bearing 140B mounted on the shaft 102, a cover member 160 coupled to the base member 101B, and a fixing screw 165 passing through the cover member 160 and coupled to the shaft 102.

The pivot bearing 140B includes an inner case 141B contacting an external circumferential surface of the shaft 102, an external case 148 disposed outside the inner case 141B and press fit into the swing arm 131, and a plurality of bearing members 147 interposed between the inner case 141B and the external case 148. The inner case 141B includes a lower end portion 143B received in the shaft circumference groove 104B.

The HSA mounting structure 170B includes an “escape blocker” that further prevents the lower end portion 143B of the inner case 141B from being released from the shaft circumference groove 104B, such as when the HSA 130B is rotated before the fixing screw 165 is coupled. The escape blocker may include a protrusion 144 protruding from a side surface of the lower end portion 143B of the inner case 141B, and a protrusion capture groove 106 formed complementary to the protrusion 144 in the side surface of the shaft circumference groove 104B. The protrusion 144 and the protrusion capture groove 106 may be manufactured using, for example, a micro-machining process. Further, the locations of the protrusion capture groove 106 and the protrusion 144 may be switched where the groove is formed on the lower end portion 143B of the inner case 141B and the protrusion is formed on an inner surface of the shaft circumference groove 104B.

The respective dimensions of the protrusion 144 and the protrusion capture groove 106 may allow the HSA 130B to be seated in the shaft circumference groove 104B when a force is intentionally applied in the Z direction while preventing the HSA 130B from being released from the shaft circumference groove 104B when no force is intentionally applied in the Z direction. That is, when the lower end portion 143B of the inner case 141B is received in the shaft circumference groove 104B, when the HSA 130B is rotated around the shaft 102, the protrusion 144 is captured in the protrusion capture groove 106 to prevent the HSA 130B from moving in the Z direction. Accordingly, damage to the head slider 135 and the disks 112 from collision of the head slider 135 with the disks 112, which may occur when the head slider 135 (see FIG. 3) is parked on the parking zone 113 (see FIG. 3) before the cover member 160 is coupled to the base member 101B, is prevented.

Once the head slider 135 is parked, the cover member 160 may be coupled to the base member 101B, and the fixing screw 165 passes through the cover member 160 and may be threadedly coupled to the shaft 102. Since the HSA 130B is retained by the cover member 160 as well as the base member 101B due to the fixing screw 165, the HSA 130B can further be prevented from vibrating.

Referring to FIG. 6, the exemplary HSA mounting structure 170C includes a shaft 102 protruding upwards, a base member 101C including a shaft circumferential groove 104C formed around the shaft 102, an HSA 130C including a pivot bearing 140C placed on the shaft 102, a cover member 160 coupled to the base member 101C, and a fixing screw 165 passing through the cover member 160 and coupled to the shaft 102.

The pivot bearing 140C includes an inner case 141C contacting an external circumferential surface of the shaft 102, an external case 148 disposed outside the inner case 141C and press fit into the swing arm 131, and a plurality of bearing members 147 interposed between the inner case 141C and the external case 148. The inner case 141C includes a lower end portion 143C, which may be received in the shaft circumference groove 104C.

The exemplary HSA mounting structure 170C illustrated in FIG. 6 includes an escape blocker that prevents the lower end portion 143C of the inner case 141C from releasing from the shaft circumference groove 104C, such as when the HSA 130C is rotated before the fixing screw 165 is coupled. The escape blocker includes a pivot bearing holder 108 adhered to a side surface of the shaft circumference groove 104C. For example, the pivot bearing holder 108 may be a ring type member formed of an elastic material such as rubber, urethane or the like, and elastically press fit between the side surface of the lower end portion 143C of the inner case 141C and the shaft circumference groove 104C. The escape blocker may include a protrusion 145 protruding from the side surface of the lower end portion 143C of the inner case 141C and contacting a lower end of the pivot bearing holder 108. The protrusion 145 may be manufactured using, for example, a micro-machining process.

The lower end portion 143C of the inner case 141C may be seated in the shaft circumference groove 104C or removed from the shaft circumference groove 104C when a force is intentionally applied in the Z direction, but the HSA 130C may not move in the Z direction unless such intentional force is applied due to press fit of the pivot bearing holder 108 between the side surface of the lower end portion 143C and the interior surface of the shaft circumference groove 104C.

That is, once the lower end portion 143C of the inner case 141C is seated in the shaft circumference groove 104C, the HSA 130C is prevented from moving in the Z direction due to press fit of the pivot bearing holder 108. In addition, since the protrusion 145 is captured by the lower end of the pivot bearing holder 108, the HSA 130C can be additionally prevented from moving in the Z direction. Accordingly, damage to the head slider 135 and the disks 112 from collision of the head slider 135 with the disks 112, which may occur when the head slider 135 (see FIG. 3) is parked on the parking zone 113 (see FIG. 3) before the cover member 160 is coupled to the base member 101C, is prevented. Although the protrusion 145 may contact the lower end of the pivot bearing holder 108, as illustrated in FIG. 6, the present general inventive concept is not limited thereto. That is, the protrusion may be press fit into an inner surface of the pivot bearing holder 108 so that friction between the pivot bearing holder 108 and the lower end portion 143C of the inner case 141C is increased.

After the head slider 135 is parked, the cover member 160 may be coupled to the base member 101C, and the fixing screw 165 may be inserted through the cover member 160 and coupled to the shaft 102. Since the position of the HSA 130C is maintained by the cover member 160, which is coupled to the periphery of the base member 101C and to the HSA 130C by the fixing screw 165, the HSA 130C can further be prevented from vibrating.

According to the HSA mounting structure of the present general inventive concept and the HDD implementing the HSA mounting structure, the number of coupling screws to mount the HSA is limited to one. Accordingly, since the HSA mounting structure can be manufactured and mounted using simple processes, the assembling costs of the HDD can be reduced, and the productivity of the HDD manufacturing process can be improved.

In addition, when only one fixing screw is coupled to the shaft that is integrally formed with the base member by, for example, a molding process, the occurrence of screw jams in the shaft is reduced. Accordingly, the HDD can be repaired or parts thereof can be reused.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A head stack assembly (HSA) mounting structure, comprising:
a base member including a shaft protruding upwards and a shaft circumference groove formed around the shaft;
an HSA that is rotatably placed on the shaft, and comprising:
a pivot bearing including an inner case contacting the shaft and including a lower end portion received in the shaft circumference groove, an external case disposed outside of the inner case, and at least one bearing member interposed between the inner case and the external case;
a head slider supporting member coupled to the external case; and
a head slider mounted at an end of the head slider supporting member;
a cover member coupled to the base member; and
a fixing screw passing through the cover member and coupled to the shaft.

2. The HSA mounting structure of claim 1, further comprising:
an escape blocker engaging the lower end portion of the inner case so as to prevent release thereof from the shaft circumference groove before the fixing screw is coupled.

3. The HSA mounting structure of claim 2, wherein the escape blocker comprises:
a protrusion protruding from a side surface of the lower end portion of the inner case; and
a protrusion capture groove concaved to capture the protrusion in a side surface of the shaft circumference groove.

4. The HSA mounting structure of claim 2, wherein the escape blocker comprises:
a pivot bearing holder fixed to the side surface of the shaft circumference groove, elastically pressing the side surface of the lower end portion of the inner case inserted in the shaft circumference groove, and formed of an elastic material.

5. The HSA mounting structure of claim 4, wherein the escape blocker further comprises:
a protrusion protruding from the side surface of the inner case to be press fit into the pivot bearing holder or to contact a lower end of the pivot bearing holder.

6. A hard disk drive (HDD) comprising:
a base member including a shaft protruding upwards and a shaft circumference groove formed around the shaft;
a disk to store data thereon and mounted on the base member;
an HSA that is rotatably placed on the shaft, and comprising:
a pivot bearing including an inner case contacting the shaft, and including a lower end portion received in the shaft circumference groove, an external case disposed outside of the inner case, and at least one bearing member interposed between the inner case and the external case;
a head slider supporting member coupled to the external case; and
a head slider mounted at an end of the head slider supporting member;
a cover member coupled to the base member; and
a fixing screw passing through the cover member and coupled to the shaft.

7. The HDD of claim 6, further comprising:
an escape blocker engaging the lower end portion of the inner case so as to prevent release thereof from the shaft circumference groove before the fixing screw is coupled.

8. The HDD of claim 7, wherein the escape blocker comprises:
a protrusion protruding from a side surface of the lower end portion of the inner case; and
a protrusion capture groove to capture the protrusion in a side surface of the shaft circumference groove.

9. The HDD of claim 7, wherein the escape blocker comprises:
a pivot bearing holder fixedly coupled to the side surface of the shaft circumference groove, elastically pressing the side surface of the lower end portion of the inner case inserted in the shaft circumference groove, and formed of an elastic material.

10. The HDD of claim 9, wherein the escape blocker further comprises:
a protrusion protruding from the side surface of the inner case to be press fit into the pivot bearing holder or in contact with a lower end of the pivot bearing holder.

11. A head stack assembly mount comprising:
a base having a mounting surface;
a shaft extending from the mounting surface of the base;
a shaft circumference groove formed in the mounting surface of the base around the circumference of the shaft;
a swing arm to retain a plurality of read/write heads in spaced apart relationship one to another; and
a bearing assembly to couple a pivot point of the swing arm with the shaft, the bearing assembly being received in the groove of the base when mounted on the shaft.

12. The head stack assembly mount of claim 11, wherein the shaft circumference groove and the bearing assembly are respectively sized to form a press fit.

13. The head stack assembly mount of claim 11, further comprising:
a cover coupled to the base around a periphery thereof; and
a fixing screw threadedly coupled to the shaft though the cover.

14. The head stack assembly mount of claim 11, further comprising;
an escape blocker formed between the shaft circumference groove and the bearing assembly and including a complementary groove and protrusion to retain the bearing assembly in the shaft circumference groove.

15. The head stack assembly mount of claim 14, wherein the groove is formed in a circumferential surface of the shaft circumference groove and the protrusion is formed on a surface of the bearing assembly.

16. The head stack assembly mount of claim 14, wherein the groove is formed in a surface of the bearing assembly and the protrusion is formed on a circumferential surface of the shaft circumference groove.

17. The head stack assembly mount of claim 11, further comprising;
an escape blocker formed between the shaft circumference groove and the bearing assembly and including a pivot bearing holder to retain the bearing assembly in the shaft circumference groove.

18. The head stack assembly mount of claim 17, wherein the pivot bearing holder is formed from an elastic material and elastically engages the bearing assembly and the shaft circumference groove.

19. The head stack assembly mount of claim 18, wherein the pivot bearing holder engages an edge surface of a protrusion on the bearing assembly.

20. A base member of a hard disk drive comprising:
a shaft protruding from a mounting surface thereof; and
a shaft circumference groove formed in the mounting surface around the periphery of the shaft.

21. The base member of claim 20, further comprising:
a protrusion capture groove formed in a circumferential surface of the shaft circumference groove.

22. The base member of claim 20, wherein the shaft is in single piece formation with the base member.
